(19) United States
(12) Patent Application Publication
(10) Pub. No.: US 2026/0247370 A1
(43) Pub. Date: Aug. 20, 2026

(54) WIRELESS COMMUNICATION DEVICE AND RESOURCE UNIT ALLOCATION METHOD THEREOF

(71) Applicant: Realtek Semiconductor Corporation, Hsinchu (TW)

(72) Inventors: Chun-Kai TSENG, Hsinchu (TW); Ya-Xin DAI, Hsinchu (TW); Shau-Yu CHENG, Hsinchu (TW)

(21) Appl. No.: 19/408,376

(22) Filed: Dec. 4, 2025

(30) Foreign Application Priority Data
Feb. 20, 2025 (TW) 114106336

(51) Int. Cl. H04W 72/121

(52) U.S. Cl. CPC H04W 72/121

(57) ABSTRACT

A wireless communication device includes a communication module and a processing unit. The communication module is configured to perform RF signal transmissions and receptions. The processing unit is configured to perform the following operations: parsing the trigger-based PPDU packets received from STAs in a list or multi-user PPDU packets transmitted to the STAs during a period to obtain MPDU sizes respectively corresponding to the STAs; calculating minimum required RU sizes of the STAs the site the MPDU sizes and the list; when the MPDU size of a key STA of the STAs is normal, determining whether the RU sizes of the STAs meet the corresponding minimum required RU sizes; and removing one of the STAs not meet the corresponding minimum required RU size from the list to update the list and performing an RU allocation for the remained STAs.

### RELATED APPLICATIONS

This application claims priority to Taiwan Application Serial Number 114106336, filed Feb. 20, 2025, which is herein incorporated by reference.

### BACKGROUND

### Technical Field

The present disclosure relates to resource unit (RU) allocation for a wireless communication system, and more particularly to a wireless communication device and an RU allocation method thereof performing an RU allocation.

### Description of Related Art

Currently, most wireless communication systems adopt technologies such as multiple-input multiple-output (MIMO) and orthogonal frequency division multiple access (OFDMA) for enabling access points (APs) to efficiently manage bandwidth and expand throughput. In addition, the APs can perform an RU allocation for each station (STA) according to an RU structure, and how to perform the RU allocation to improve the efficiency of the wireless communication systems is one of the objectives in the related industries.

### SUMMARY

The present disclosure provides a wireless communication device which includes a communication module and a processor. The communication module is configured to receive and transmit radio frequency signals. The processor is coupled to the communication module and is configured to perform the following operations: parsing trigger-based physical layer protocol data unit (PPDU) packets received respectively from STAs in a scheduled STA list or an MU PPDU packet transmitted to the STAs during a period, so as to obtain media access control layer protocol data unit (MPDU) sizes respectively corresponding to the STAs; calculating minimum required RU sizes respective of the STAs according to the MPDU sizes and the scheduled STA list; in response to determining that the MPDU size of a key STA among the STAs is normal, determining whether the RU sizes of the STAs respectively meet the minimum required RU sizes in correspondence; and removing at least one of the STAs not meeting at least one of the minimum required RU sizes in correspondence from the scheduled STA list, so as to update the scheduled STA list and perform an RU allocation for at least one remained STA in the updated scheduled STA list.

The present disclosure further provides an RU allocation method which is applicable to a wireless communication device and includes: parsing trigger-based PPDU packets received respectively from STAs in a scheduled STA list or an MU PPDU packet transmitted to the STAs during a period, so as to obtain MPDU sizes respectively corresponding to the STAs; calculating minimum required RU sizes respective of the STAs according to the MPDU sizes and the scheduled STA list; in response to determining that the MPDU size of a key STA among the STAs is normal, determining whether the RU sizes of the STAs respectively meet the minimum required RU sizes in correspondence; and removing at least one of the STAs not meeting at least one of the minimum required RU sizes in correspondence from the scheduled STA list, so as to update the scheduled STA list and perform an RU allocation for at least one remained STA in the updated scheduled STA list.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2A and FIG. 2B are schematic diagrams of a downlink OFDMA transmission and an uplink OFDMA transmission between the wireless AP device and the wireless STA devices in the wireless communication system in FIG. 1, respectively.

FIG. 3 exemplarily illustrates an 80 MHz RU structure.

FIG. 4 is a schematic block diagram of a wireless communication device in accordance with some embodiments of the present disclosure.

FIG. 5 is a schematic flowchart of an RU allocation method in accordance with some embodiments of the present disclosure.

### DETAILED DESCRIPTION

The detailed explanation of the disclosure is described as following. The described preferred embodiments are presented for purposes of illustrations and description, and they are not intended to limit the scope of the disclosure.

It will be understood that, although the terms “first,” “second,” etc., may be used herein to describe various signals, information, and/or values, these signals, information, and/or values should not be limited by these terms. These terms are only used to distinguish a signal, information, and/or value from another signal, information, and/or value.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes, in which the HT modes, the VHT modes, the HE modes, and the EHT modes respectively correspond to various generations of wireless local area networks (WLANs) such as Wi-Fi 4, Wi-Fi 5, Wi-Fi 6/6E, and Wi-Fi 7. More transmission modes are usable for a wireless communication device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

In the present disclosure, the 26-tone RU is an RU that includes 26 subcarriers, and can be denoted as an RU RU26 (i.e., the RU size is 26) in the context. Likewise, the 52-tone RU is an RU that includes 52 subcarriers, and can be denoted as an RU RU52 (i.e., the RU size is 52) in the context, and so on.

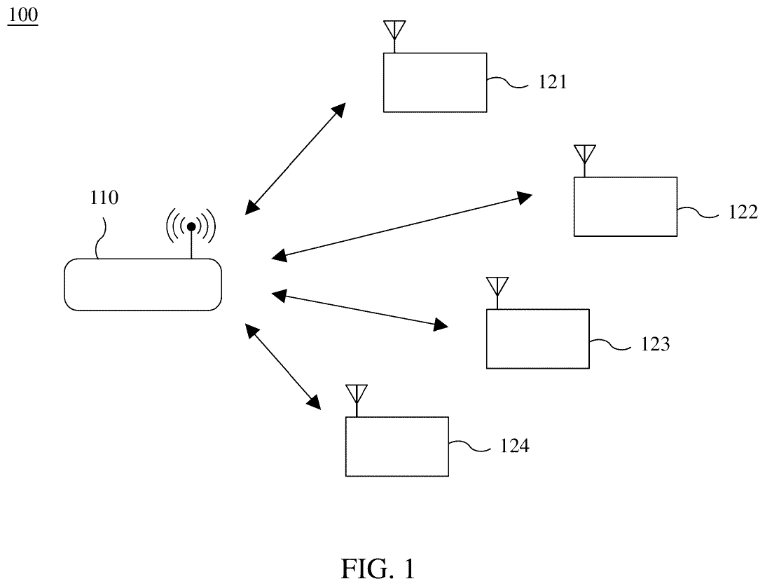

FIG. 1 is a schematic diagram of a wireless communication system 100 in accordance with some embodiments of the present disclosure. The wireless communication system 100 includes a wireless AP device 110 and wireless STA devices 121-124. The wireless AP device 110 provides wireless access services within a certain range, and each of the wireless STA devices 121-124 may perform a wireless communication connection with the wireless AP device 110 through a Wi-Fi channel (e.g., an IEEE 802.11 channel) to access a local area network and/or an external network (e.g., the Internet). The wireless communication connection between the wireless AP device 110 and any of the wireless STA devices 121-124 may include, but not limited to, a registration procedure, an authentication procedure and an access procedure, establishment and release of a wireless connection, and transmissions and/or receptions of control signals and/or transmissions and/or receptions of data signals. Each of the wireless STA devices 121-124 may be, for example, a smartphone, a tablet, a notebook, or another device with wireless signal transmission and reception functions. In addition, the wireless AP device 110 may be, for example, a wireless router, a wireless switch, or a wireless STA device with AP functions. In other embodiments, the wireless STA devices 121-124 may have AP functions. It should be noticed that the number of wireless STA devices in the present disclosure is not limited to that shown in FIG. 1.

The wireless communication system 100 may support the OFDMA technology. In the wireless communication system 100, the wireless AP device 110 may separate a wireless channel resource with a particular bandwidth into plural RUs, and allocate RUs corresponding to the wireless STA devices 121-124, such that the frequency bands used by the wireless STA devices 121-124 for signal transmissions and receptions are not overlapped with each other at the same time. In addition, the wireless communication system 100 may support the technologies of MIMO, multiple-input single-output (MISO), single-input multiple-output (SIMO), and/or single-input single-output (SISO).

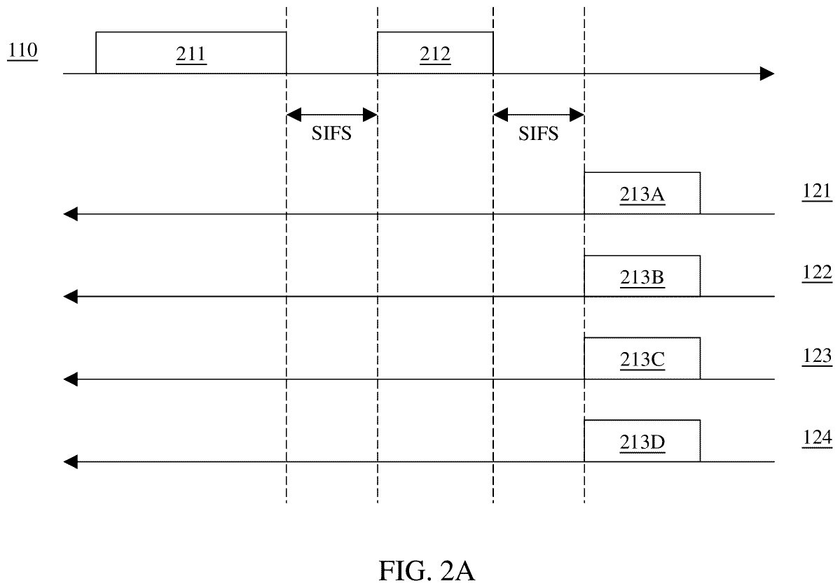

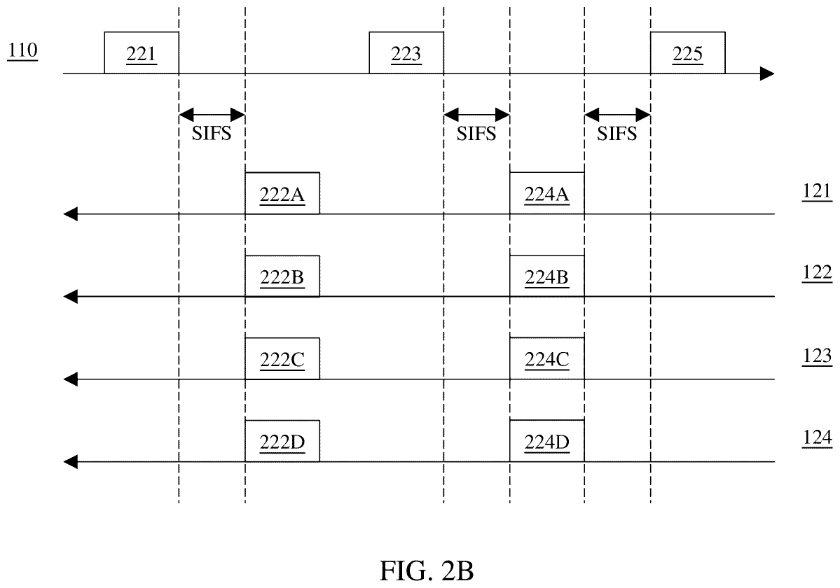

In the wireless communication system 100, the wireless AP device 110 may perform OFDMA with the wireless STA devices 121-124. FIG. 2A and FIG. 2B are schematic diagrams of a downlink OFDMA transmission and an uplink OFDMA transmission between the wireless AP device 110 and the wireless STA devices 121-124 in the wireless communication system 100 in FIG. 1, respectively. In the downlink OFDMA transmission, as shown in FIG. 2A, the wireless AP device 110 transmits a multi-user (MU, or referred to as multi-STA) PPDU packet 211 to the wireless STA devices 121-124, including a preamble and PPDU data portions respectively corresponding to the wireless STA devices 121-124, and then transmits an MU block acknowledgement request (MU BAR) frame 212 after a short inter-frame space (SIFS). The wireless STA devices 121-124 may respectively obtain the PPDU data portions by decoding the MU PPDU packet 211, and respectively transmit block acknowledgement (ACK) frames 213A-213D back to the wireless AP device 110 at the end of the short inter-frame space interval after receiving the MU BAR frame 212.

While in the uplink OFDMA transmission, as shown in FIG. 2B, the wireless AP device 110 transmits a buffer status report poll (BSRP) frame 221 to the wireless STA devices 121-124, and then the wireless STA devices 121-124 respectively transmit buffer status report (BSR) frames 222A-222D to the wireless AP device 110 in response to the BSRP frame 221 after an SIFS, so as to report the total byte count of the data to be transmitted. Then, the wireless AP device 110 transmits a basic trigger frame 223 to the wireless STA devices 121-124, including RU allocations, transmission rates, and target receive signal strength indicators (RSSIs) of the wireless STA devices 121-124. At receiving the basic trigger frame 223 after an SIFS, the wireless STA devices 121-124 respectively transmit trigger-based PPDU packets 224A-224D with uplink data to the wireless AP device 110. In the end, the wireless AP device 110 transmits an MU block ACK frame 225 back to the wireless STA devices 121-124 at the end of the SIFS after receiving the trigger-based PPDU packets 224A-224D.

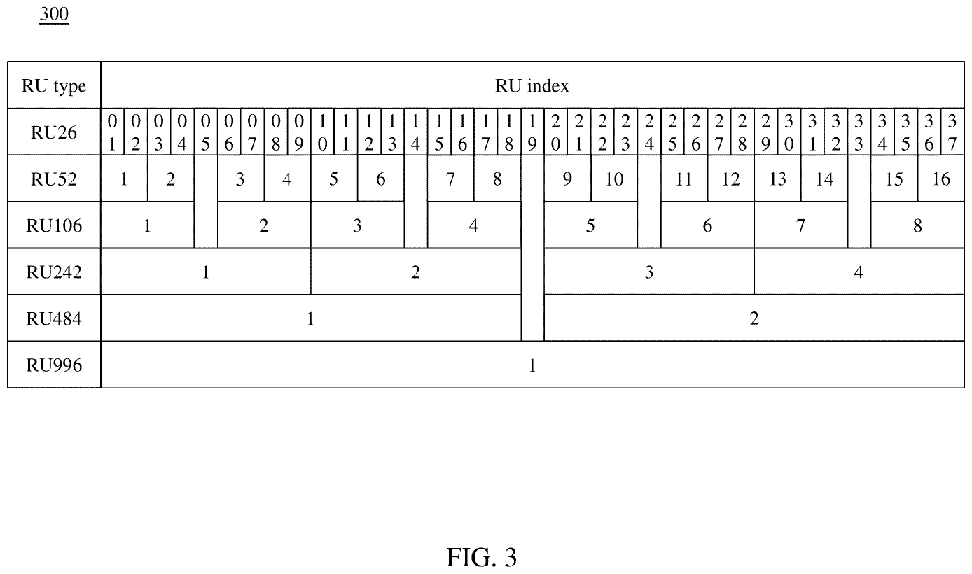

FIG. 3 exemplarily illustrates an 80 MHz RU structure 300 which complies with the WLAN standards. As shown in FIG. 3, the 80 MHz RU structure 300 includes 37 RUs RU26 (respectively with the indices of 1-37), 16 RUs RU52 (respectively with the indices of 1-16), 8 RUs RU106 (respectively with the indices of 1-8), 4 RUs RU242 (respectively with the indices of 1-4), 2 RUs RU484 (respectively with the indices of 1-2), and 1 RU RU996 (with the index of 1). The allocated RU may be any of the abovementioned RUs. Each of the RUs RU52, RU106, RU242, RU484, and RU996 covers at least two RUs RU26, and the RUs with the same number of subcarriers are not overlapped with each other. For example, the RU RU242 with the index of 1 covers the RUs RU26 respectively with the indices of 1-9, the RU RU242 with the index of 2 covers the RUs RU26 respectively with the indices of 10-18, and these two RUs RU242 are non-overlapped with respect to each other.

The wireless AP device 110 may allocate RUs with the same number of subcarriers for the wireless STA devices 121-124 according to the RU structure 300 shown in FIG. 3, for example, but not limited to, allocating the RUs RU242 with the indices of 1-4 respectively for the wireless STA devices 121-124, or may allocate RUs with different indices and different numbers of subcarriers for the wireless STA devices 121-124, for example, but not limited to, allocating the RUs RU106 with the indices of 1 and 2 respectively for the wireless STA devices 121, 122 and allocating the RU RU242 with the indices of 2 and 3 respectively for the wireless STA devices 123, 124.

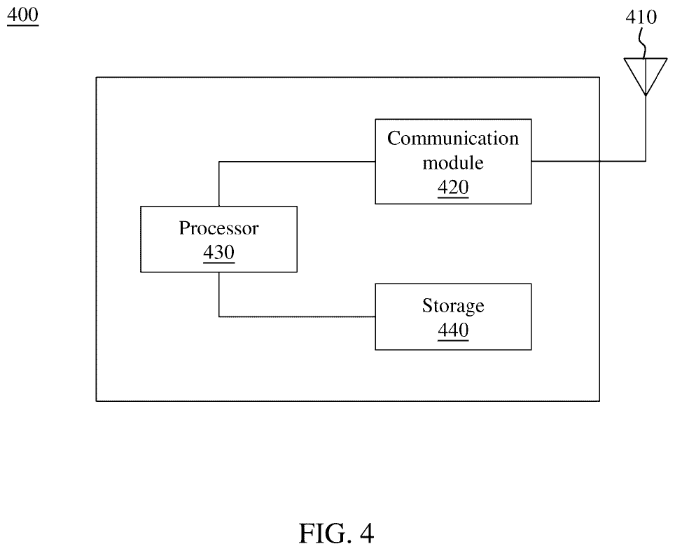

FIG. 4 is a schematic block diagram of a wireless communication device 400 in accordance with some embodiments of the present disclosure. The wireless communication device 400 may be any of the wireless AP device 110 and the wireless STA devices 121-124 in FIG. 1, or any wireless communication device that can be a beamformer. The wireless communication device 400 includes an antenna 410, a communication module 420, a processor 430, and a storage 440.

The antenna 410 is configured to perform wireless transmissions and receptions by transmitting and receiving radio frequency (RF) signals. In some embodiments, the wireless communication device 400 may include plural antennas 410 that may be configured to perform multiple-inputs and/or multiple-output RF signal transmissions and receptions.

The communication module 420 is coupled to the antenna 410 and is configured for RF signal transmissions and receptions, such as receiving and demodulating RF signals into packets (e.g., control signals or data signals) and modulating packets that are to be transmitted into RF signals.

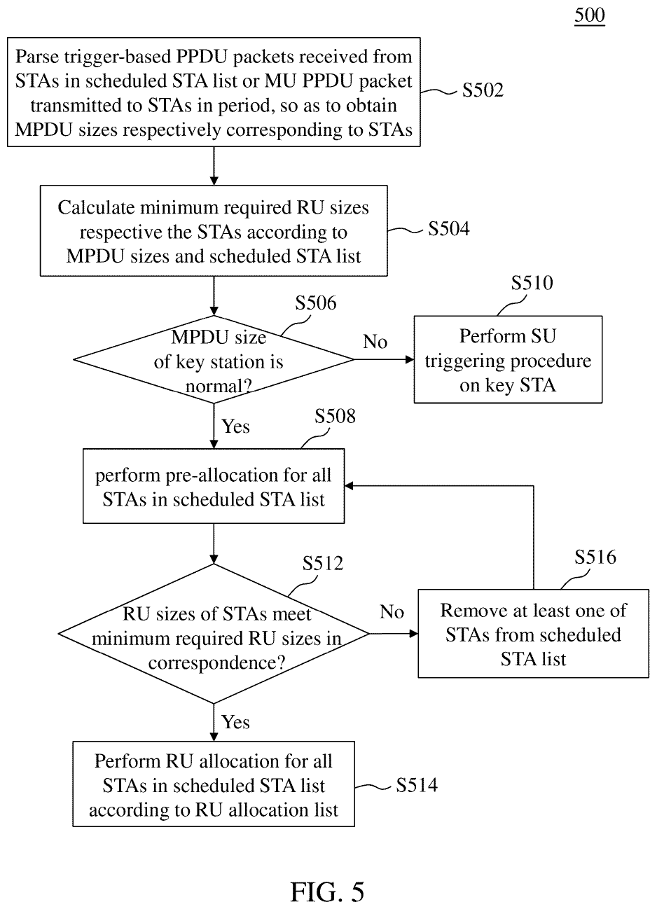

The processor 430 is coupled to the communication module 420 and the storage 440 and is configured to process packets and determine the transmission mode of the communication module 420 according to the system status for performing signal transmissions and receptions. The processor 430 may be, for example, but not limited to, a microprocessor or an application-specific integrated circuit (ASIC). In particular, the processor 430 may be utilized to perform an RU allocation method, and the detail thereof can be referred to the description of FIG. 5 as follows.

The storage 440 may be any data storage device that can be read and executed by the processor 430. The storage 440 may be, for example, but not limited to, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk drive, a solid-state drive, a flash memory, or another data storage device suitable for storing bit data and/or program codes.

FIG. 5 is a schematic flowchart of an RU allocation method 500 in accordance with some embodiments of the present disclosure. The RU allocation method 500 is applicable to the wireless AP device 110 of the wireless communication system 100 in FIG. 1, the wireless communication device 400 in FIG. 4, and/or another device that can be as an AP. The RU allocation method 500 is performed by an AP, e.g., performed by the processor 430 of the wireless communication device 400, and includes the following operations. In the beginning, Operation S502 is performed to parse trigger-based PPDU packets received from the STAs in the scheduled STA list or an MU PPDU packet transmitted to the STAs in a period (e.g., in 1 or 2 seconds), so as to obtain the MPDU sizes respectively corresponding to the STAs, and then perform statistics on these MPDU sizes, so as to obtain averaged MPDU sizes. If the obtained MPDU size is abnormal (e.g., the MPDU size is 0), the MPDU size is determined to be invalid.

In some embodiments, Operation S502 further includes parsing transmitting SU PPDU packets or received SU PPDU packets in a period for statistical reference, especially where there are not a large number of trigger-based PPDU packets or MU PPDU packets. That is, for downlink transmissions, the MPDU sizes of the SU PPDU packets transmitted to the key STA in a period may further be counted, and for uplink transmissions, the MPDU sizes of the SU PPDU packets received from the key STA in a period may further be counted. The key STA may be, but is not limited to, a primary STA or an STA with a particular requirement, e.g., a latency-sensitive STA.

Then, Operation S504 is performed to calculate the minimum required RU sizes respective of the STAs according to the MPDU sizes and the scheduled STA list. The scheduled STA list includes the MPDU sizes and the RU physical rates (the MCS indices and the numbers of streams) used for the STAs. The minimum required RU size I_{RU} of each STA meets Formula (1) as follows:

$${I}_{MPDU} / ( {I}_{RU} \times {r}_{MCS} ) \leq MAX\_PPDU \_time , \qquad ( 1 )$$

where I_{MPDU} is the MPDU size, r_{MCS} is the transmission rate corresponding to the MCS index, and MAX_PPDU_time is the maximum PPDU packet transmission time. According to the Wi-Fi system specification, the maximum transmission time of each PPDU packet may be approximately 5 milliseconds.

Afterwards, Operation S506 is performed to determine whether the MPDU size of the key STA in the scheduled STA list is normal (i.e., whether the minimum required RU size of the key STA can be estimated). If it is determined that the MPDU size of the key STA in the scheduled STA list is normal (i.e., the minimum required RU size of the key STA can be estimated), Operation S508 is performed to perform a pre-allocation for all the STAs according to the transmitted buffer information or the BSR lengths of all STAs in the scheduled STA list, so as to obtain an RU allocation list corresponding to the scheduled STA list (including the RU size allocated for each STA). The pre-allocation performed on the STAs may be an equally divided allocation (the RU size allocated for each STA is identical) or a non-equally divided allocation (e.g., the allocation in which the channel resource usage is maximized).

Otherwise, if it is determined that the MPDU size of the key STA in the scheduled STA list is abnormal (i.e., the minimum required RU size of the key STA cannot be estimated), Operation S510 is performed to perform an SU traffic procedure on the key STA. In a case of downlink transmission, Operation S510 may transmit an SU PPDU packet to the key STA through a full band. Relatively, in a case of uplink transmission, Operation S510 may be that an SU full-band triggering procedure is performed on the key STA, such that the key STA uploads an SU PPDU packet through a full band.

After Operation S508, Operation S512 is performed to determine whether the RU sizes of the STAs meet the minimum required RU sizes in correspondence. If the RU sizes of all the STAs meet the minimum required RU sizes in correspondence, Operation S514 is performed to perform an RU allocation for all STAs in the scheduled STA list according to the RU allocation list. Oppositely, if the RU sizes of some STAs are non-conforming, i.e., not meeting the minimum required RU sizes in correspondence (for example, the RU size of an STA is 26, and the minimum required RU size corresponding thereto is 52), Operation S516 is performed to remove at least one of the STAs from the scheduled STA list for updating the scheduled STA list, and then Operation S508 is returned with the updated scheduled STA list.

After the AP performs the RU allocation for all STAs in the scheduled STA list according to the RU allocation list and then transmits an MU PPDU packet, if a transmission or reception abnormality occurs, e.g., the AP cannot successfully transmit any MPDU to an STA (such STA cannot successfully receive the data transmitted by the AP), or if the AP receives a QoS null trigger-based PPDU packet from an STA after receiving a BSR with a non-zero length from the same STA, the AP may obtain the MPDU sizes (including abnormal MPDU sizes) by parsing its transmitting MU PPDU packet or received PPDU packets. Then, in a condition in which the next MU PPDU packet is transmitted, if the MPDU size of the key STA in the scheduled STA list is abnormal, an SU traffic procedure is performed on the key STA. In particular, in an uplink transmission scenario, in addition to the full-band trigger-based PPDU packet configuration, the length of the trigger-based PPDU packet may also be increased. The AP performs an MU traffic procedure after performing an SU traffic procedure to estimate new MPDU sizes.

In addition, by performing an RU allocation for the remained STAs in the scheduled STA list after reducing the scheduled STA list (removing at least one of the STAs from the scheduled STA list), the remained STAs can have a higher possibility to be allocated with a larger RU size. Taking an equally divided RU size for example, Table 1 lists maximum supported STAs and possible number of STAs, RU types, and RU indices corresponding to channels with various bandwidths. According to Table 1, in an environment with a 20 MHz channel bandwidth, the number of maximum supported STAs of the AP is 9, and when the number of STAs in this environment is 2, the RU type allocated for each STA is RU106, and the RU indices corresponding to the STAs are 1 and 2, respectively; when the number of STAs in this environment is 3 or 4, the RU type allocated for each STA is RU52, the RU indices corresponding to the STAs are 1-3 or 1-4, respectively; when the number of STAs in this environment is 5-9, the RU type allocated for each STA is RU26, and the RU indices corresponding to the STAs are 1-5/1-6/ . . . /1-9, respectively (depending on the number of STAs). The description about the other channel bandwidths may be derived analogously from the description about the 20 MHz channel bandwidth and is not repeated herein. For example, in an environment with an 80 MHz channel bandwidth, if the number of STAs in the scheduled STA list is 9-16, the RU type allocated for each STA in the scheduled STA list by the AP is RU52; after reducing the scheduled STA list to decrease the number of STAs to 8, the RU type allocated for each STA in the scheduled STA list by the AP is changed to RU106, i.e., the RU size allocated for each STA is increased from 52 to 106.

TABLE 1

| | Maximum | | | |
|---|---|---|---|---|
| | supported | Number of | | |
| Bandwidth | STAs | STAs | RU type | RU indices |
| 20 MHz | 9 | 2 | RU106 | 1-2 |
| | | 3-4 | RU52 | 1-3/1-4 |
| | | 5-9 | RU26 | 1-5/1-6/ . . . /1-9 |
| 40 MHz | 18 | 2 | RU242 | 1-2 |
| | | 3-4 | RU106 | 1-3/1-4 |
| | | 5-8 | RU52 | 1-5/1-6/ . . . /1-8 |
| | | 9-18 | RU26 | 1-9/1-10/ . . . /1-18 |
| 80 MHz | 37 | 2 | RU484 | 1-2 |
| | | 3-4 | RU242 | 1-3/1-4 |
| | | 5-8 | RU106 | 1-5/1-6/ . . . /1-8 |
| | | 9-16 | RU52 | 1-9/1-10/ . . . /1-16 |
| | | 17-37 | RU26 | 1-17/1-18/ . . . /1-37 |
| 160 MHz | 74 | 2 | RU996 | 1-2 |
| | | 3-4 | RU484 | 1-3/1-4 |
| | | 5-8 | RU242 | 1-5/1-6/ . . . /1-8 |
| | | 9-16 | RU106 | 1-9/1-10/ . . . /1-16 |
| | | 17-32 | RU52 | 1-17/1-18/ . . . /1-32 |
| | | 33-74 | RU26 | 1-33/1-34/ . . . /1-74 |

Summarizing the above description, the present disclosure provides a wireless communication device which includes a communication module and a processor. The communication module is configured to receive and transmit radio frequency signals. The processor is coupled to the communication module and is configured to perform the following operations: parsing trigger-based PPDU packets received respectively from STAs in a scheduled STA list or an MU PPDU packet transmitted to the STAs during a period, so as to obtain MPDU sizes respectively corresponding to the STAs; calculating minimum required RU sizes respective of the STAs according to the MPDU sizes and the scheduled STA list; in response to determining that the MPDU size of a key STA among the STAs is normal, determining whether the RU sizes of the STAs respectively meet the minimum required RU sizes in correspondence; and removing at least one of the STAs not meeting at least one of the minimum required RU sizes in correspondence from the scheduled STA list, so as to update the scheduled STA list and perform a first RU allocation for at least one remained STA in the updated scheduled STA list. In some embodiments, in response to determining that the MPDU size of the key STA is abnormal, the processor is further configured to perform an SU traffic procedure on the key STA. In some embodiments, in response to determining that the MPDU size of the key STA is abnormal, the processor is further configured to transmit an SU PPDU packet to the key STA through a full band. In some embodiments, in response to determining that the MPDU size of the key STA is abnormal, the processor is further configured to perform an SU full-band triggering procedure on the key STA, such that the key STA uploads an SU trigger-based PPDU packet through a full band accordingly. In some embodiments, in response to determining that the MPDU size of the key STA is abnormal, the SU full-band triggering procedure performed by the processor on the key STA further comprises increasing a trigger-based PPDU packet length of the remained STA. In some embodiments, the MPDU sizes are obtained by further parsing an SU PPDU packet transmitted to the key STA during the period or an SU PPDU packet received from the key STA. In some embodiments, the key STA is a primary STA in the scheduled STA list. In some embodiments, the first RU allocation is an equally divided allocation. In some embodiments, the minimum required RU size I_{RU} of each of the STAs meets I_{MPDU}/(I_{RU}×I_{MCS})≤MAX_PPDU_time, where I_{MPDU} is the MPDU size corresponding to each of the STAs, r_{MCS} is a transmission rate of an MCS index used by each of the STAs, and MAX_PPDU_time is a maximum PPDU packet transmission time. In some embodiments, in response to the STAs meeting the minimum required RU sizes, the processor is further configured to perform a second RU allocation of the STAs.

Summarizing the above description, the present disclosure further provides an RU allocation method which is applicable to a wireless communication device and includes: parsing trigger-based PPDU packets received respectively from STAs in a scheduled STA list or an MU PPDU packet transmitted to the STAs during a period, so as to obtain MPDU sizes respectively corresponding to the STAs; calculating minimum required RU sizes respective of the STAs according to the MPDU sizes and the scheduled STA list; in response to determining that the MPDU size of a key STA among the STAs is normal, determining whether the RU sizes of the STAs respectively meet the minimum required RU sizes in correspondence; and removing at least one of the STAs not meeting at least one of the minimum required RU sizes in correspondence from the scheduled STA list, so as to update the scheduled STA list and perform a first RU allocation for at least one remained STA in the updated scheduled STA list. In some embodiments, the RU allocation method further includes: in response to determining that the MPDU size of the key STA is abnormal, performing an SU traffic procedure on the key STA. In some embodiments, the RU allocation method further includes: in response to determining that the MPDU size of the key STA is abnormal, transmitting an SU PPDU packet to the key STA through a full band. In some embodiments, the RU allocation method further includes: in response to determining that the MPDU size of the key STA is abnormal, performing an SU full-band triggering procedure on the key STA, such that the key STA uploads an SU trigger-based PPDU packet through a full band accordingly. In some embodiments, in response to determining that the MPDU size of the key STA is abnormal, the SU full-band triggering procedure further comprises increasing a trigger-based PPDU packet length of the remained STA. In some embodiments, the MPDU sizes are obtained by further parsing an SU PPDU packet transmitted to the key STA during the period or an SU PPDU packet received from the key STA. In some embodiments, the key STA is a primary STA in the scheduled STA list. In some embodiments, the first RU allocation is an equally divided allocation. In some embodiments, the minimum required RU size I_{RU} of each of the STAs meets I_{MPDU}/(I_{RU}×MCS)≤MAX_PPDU_time, where I_{MPDU} is the MPDU size corresponding to each of the STAs, r_{MCS} is a transmission rate of an MCS index used by each of the STAs, and MAX_PPDU_time is a maximum PPDU packet transmission time. In some embodiments, the RU allocation method further includes: in response to the STAs meeting the minimum required RU sizes, performing a second RU allocation of the STAs.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A wireless communication device, comprising:
a communication module configured to receive and transmit radio frequency signals; and
a processor coupled to the communication module and configured to perform the following operations:
parsing a plurality of trigger-based physical layer protocol data unit (PPDU) packets received respectively from a plurality of stations (STAs) in a scheduled STA list or a multi-user (MU) PPDU packet transmitted to the plurality of STAs during a period, so as to obtain a plurality of media access control layer protocol data unit (MPDU) sizes respectively corresponding to the plurality of STAs;
calculating a plurality of minimum required resource unit (RU) sizes respective of the plurality of STAs according to the plurality of MPDU sizes and the scheduled STA list;
in response to determining that the MPDU size of a key STA among the plurality of STAs is normal, determining whether a plurality of RU sizes of the plurality of STAs respectively meet the plurality of minimum required RU sizes in correspondence; and
removing at least one of the plurality of STAs not meeting at least one of the plurality of minimum required RU sizes in correspondence from the scheduled STA list, so as to update the scheduled STA list and perform a first RU allocation for at least one remained STA in the updated scheduled STA list.

2. The wireless communication device of claim 1, wherein in response to determining that the MPDU size of the key STA is abnormal, the processor is further configured to perform a single-user (SU) traffic procedure on the key STA.

3. The wireless communication device of claim 2, wherein in response to determining that the MPDU size of the key STA is abnormal, the processor is further configured to transmit an SU PPDU packet to the key STA through a full band.

4. The wireless communication device of claim 2, wherein in response to determining that the MPDU size of the key STA is abnormal, the processor is further configured to perform an SU full-band triggering procedure on the key STA, such that the key STA uploads an SU trigger-based PPDU packet through a full band accordingly.

5. The wireless communication device of claim 4, wherein in response to determining that the MPDU size of the key STA is abnormal, the SU full-band triggering procedure performed by the processor on the key STA further comprises increasing a trigger-based PPDU packet length of the at least one remained STA.

6. The wireless communication device of claim 1, wherein the plurality of MPDU sizes are obtained by further parsing an SU PPDU packet transmitted to the key STA during the period or an SU PPDU packet received from the key STA.

7. The wireless communication device of claim 1, wherein the key STA is a primary STA in the scheduled STA list.

8. The wireless communication device of claim 1, wherein the first RU allocation is an equally divided allocation.

9. The wireless communication device of claim 1, wherein the minimum required RU size I_{RU} of each of the plurality of STAs meets the following formula:
$${I}_{MPDU} / ( {I}_{RU} \times {r}_{MCS} ) \leq MAX\_PPDU \_time ,$$
where I_{MPDU} is the MPDU size corresponding to each of the plurality of STAS, r_{MCS} is a transmission rate of a modulation and coding scheme (MCS) index used by each of the plurality of STAs, and MAX_PPDU_time is a maximum PPDU packet transmission time.

10. The wireless communication device of claim 1, wherein in response to the plurality of STAs meeting the plurality of minimum required RU sizes, the processor is further configured to perform a second RU allocation of the plurality of STAs.

11. An RU allocation method applicable to a wireless communication device, the RU allocation method comprising:
parsing a plurality of trigger-based PPDU packets received respectively from a plurality of STAs in a scheduled STA list or an MU PPDU packet transmitted to the plurality of STAs during a period, so as to obtain a plurality of MPDU sizes respectively corresponding to the plurality of STAs;
calculating a plurality of minimum required RU sizes respective of the plurality of STAs according to the plurality of MPDU sizes and the scheduled STA list;
in response to determining that the MPDU size of a key STA among the plurality of STAs is normal, determining whether a plurality of RU sizes of the plurality of STAs respectively meet the plurality of minimum required RU sizes in correspondence; and
removing at least one of the plurality of STAs not meeting at least one of the plurality of minimum required RU sizes in correspondence from the scheduled STA list, so as to update the scheduled STA list and perform a first RU allocation for at least one remained STA in the updated scheduled STA list.

12. The RU allocation method of claim 11, further comprising:
in response to determining that the MPDU size of the key STA is abnormal, performing an SU traffic procedure on the key STA.

13. The RU allocation method of claim 12, further comprising:
in response to determining that the MPDU size of the key STA is abnormal, transmitting an SU PPDU packet to the key STA through a full band.

14. The RU allocation method of claim 12, further comprising:
in response to determining that the MPDU size of the key STA is abnormal, performing an SU full-band triggering procedure on the key STA, such that the key STA uploads an SU trigger-based PPDU packet through a full band accordingly.

15. The RU allocation method of claim 14, wherein in response to determining that the MPDU size of the key STA is abnormal, the SU full-band triggering procedure further comprises increasing a trigger-based PPDU packet length of the at least one remained STA.

16. The RU allocation method of claim 11, wherein the plurality of MPDU sizes are obtained by further parsing an SU PPDU packet transmitted to the key STA during the period or an SU PPDU packet received from the key STA.

17. The RU allocation method of claim 11, wherein the key STA is a primary STA in the scheduled STA list.

18. The RU allocation method of claim 11, wherein the first RU allocation is an equally divided allocation.

19. The RU allocation method of claim 11, wherein the minimum required RU size I_{RU} of each of the plurality of STAs meets the following formula:
$${I}_{MPDU} / ( {I}_{RU} \times {r}_{MCS} ) \leq MAX\_PPDU \_time ,$$
where I_{MPDU} is the MPDU size corresponding to each of the plurality of STAs, r_{MCS} is a transmission rate of an MCS index used by each of the plurality of STAs, and MAX_PPDU_time is a maximum PPDU packet transmission time.

20. The RU allocation method of claim 11, further comprising:
in response to the plurality of STAs meeting the plurality of minimum required RU sizes, performing a second RU allocation of the plurality of STAs.
